(19) United States
(12) Patent Application Publication
(10) Pub. No.: US 2006/0207141 A1
(43) Pub. Date: Sep. 21, 2006

(54) Method and apparatus for displaying advertisements on a vehicle

(75) Inventors: John Dunlop Pitt, Glasgow (GB); Katarina Barac, Glasgow (GB); Stephen O'Neil, Coatbridge (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: AGRIPA Limited, Hillington Park (GB)

(21) Appl. No.: 10/537,276

(22) PCT Filed: Jun. 14, 2002
(86) PCT No.: PCT/GB02/02730

§ 371 Date: May 27, 2005

(30) Foreign Application Priority Data
Feb. 12, 2002 (GB) 0203209.2

(51) Int. Cl. G09F 21/04

(52) U.S. Cl. 40/590

(57) ABSTRACT

An advertising panel (20) which can be used to selectively attach advertisements to the side of a road vehicle (10) or to a fixed structure in a readily demountable manner comprises a sheet (22) of plastic material, the sheet having an image applied to a first side of the sheet. An elongate fastener (22) having a thickness greater than the sheet extends along a longitudinal edge of the sheet. The elongate fastener (22) engages with one or more slotted track members (30, 32) provided on a wall (16) or curtain (14) of the road vehicle. The track member and slot (36) may be provided in a continuous length (32), corresponding to the length of the longitudinal edge, or in discrete sections (30), which are particularly applicable for use with a curtain. Elongate fasteners (22) can be provided on the upper and lower edges of the panel (20), so that the panel is installed by threading it horizontally into the slots (36) of upper and lower track members (30, 32) simultaneously. The system requires minimal structural alterations to a vehicle (10) to enable it to carry advertising panels, and allows advertising panels to be changed easily.

This invention relates to advertisements, and relates more particularly but not exclusively to a system for selectively attaching advertisements to the sides of road vehicles or fixed sites in a readily demountable manner, and to a method of adapting road vehicles for the selective display of advertisements.

At present, static exterior advertisements are achieved using posters attached to a building surface or a panel provided on the building surface. The print medium used is typically paper which is pasted to the surface using an adhesive. Such advertisements require considerable effort to install and remove the paper medium, printing costs are relatively high and planning restrictions apply.

Furthermore, currently there are many load-carrying road vehicles having substantially vertical sides which are either plain, or carry minimal information (e.g. merely the name of a transport company). These vehicle sides are extensively exposed to the sight of the general public, not least because the majority of journeys of load-carrying road vehicles take place on public roads that are also extensively used by pedestrians and/or users of personal road transport and/or passengers in public road transport. Consequently, the sides of load-carrying road vehicles represent a facility for mobile advertising that currently tends to be used only by the vehicle owners for self-advertisement. Some use of the exteriors of road vehicles is known for advertising by organisations other than the vehicle owner, but such advertising is currently limited to public transport vehicles that carry human passengers rather than inanimate cargoes, and the advertisements are either pasted-on paper, or in the nature of bodywork painting that is substantially permanent and not changeable without time-consuming repainting of the vehicle.

U.S. Pat. No. 5,845,423 and U.S. Pat. No. 5,657,566 address the problem of providing advertisements on the sides of load-carrying road vehicles, but the effectiveness of their solutions is hampered by the fact that the vehicles need extensive structural modification in the form of added rails, mounting brackets and fasteners and the like, to allow the mounting and removal of advertisement panels. Moreover the advertisement panels themselves are complicated and relatively expensive. Moreover the advertisement panels can be used only with rigid sided vehicles, since they do not allow simple access to the side curtains of flexible sided vehicles, which provide access to the load area by allowing the removal or rolling up of flexible side curtains attached to the frame of the vehicle.

It is an object of the present invention to provide an alternative system and method for providing static exterior advertisements which require less effort to install or remove, reduce printing costs and avoid planning restrictions.

It is a further object of the present invention to provide a system and a method for enabling mobile advertisements to be selectively mounted on load-carrying road vehicles in a manner which is simple to carry out and which is cost effective, allowing the use of economical advertisement panels and the requiring minimal structural alterations to a vehicle to enable it to carry advertisement panels. It is a further object of the invention to provide a system and a method for enabling mobile advertisements to be selectively mounted on both rigid sided and flexible sided road vehicles.

As used in this specification, the term “vehicle” refers to a road vehicle possessing substantially vertical sides suitable for carrying advertisements, such sides including but not being restricted to permanently fixed sides, sides formed as one or more panels that are demountable or hinged for providing access to a cargo carried by the vehicle, and curtain sides (i.e. curtains of more or less flexible sheet material whose upper edges are suspended from the vehicle, and whose lower edges are clipped or strapped to the vehicle).

As used in this specification, the term “advertisement” refers to at least one essentially two-dimensional image having an impression on a spectator that is primarily or wholly visual.

According to a first aspect of the present invention there is provided an advertising panel for mounting to a structure, the panel comprising a sheet of plastic mesh material having an image applied to a first side of the sheet, wherein the panel has an elongate fastener provided on at least one longitudinal edge, the elongate fastener having a thickness greater than the sheet and being adapted to engage with a corresponding slot provided on the structure.

Preferably, the advertising panel is mounted to the structure of a vehicle, such as a side panel of a vehicle. Alternatively, the advertising panel is mounted to a static structure, such as an advertising hoarding.

In one preferred embodiment the elongate fastener comprises a longitudinal member held within a hem of the sheet. Preferably the hem is formed by folding an edge of the sheet around the elongate fastener and back against the sheet, then securing the edge to the sheet. Securing may be carried out by stitching, applying adhesive, thermal bonding, or any suitable method.

In another preferred embodiment the elongate fastener comprises a longitudinal member secured to the sheet by an edging strip. Preferably the edging strip passes around the elongate fastener and is secured to each side of the edge of the sheet. Securing may be carried out by stitching, applying adhesive, thermal bonding, or any suitable method.

The longitudinal member is preferably flexible, for example a rope, cord, rubber or plastic extrusion or similar. Preferably the panel has an elongate fastener provided on two opposite longitudinal edges.

Preferably the sheet is flexible. Preferably the sheet is of PVC, polyester or a combination thereof. Preferably the mesh is provided with apertures allowing air passage therethrough. Preferably the sheet has an air permeability of at least 1000 litres per second at 100 pascal.

Preferably the sheet of the advertising panel is a woven material. Preferably the warp and weft fibres are bonded to each other at their intersections.

Preferably the panel is substantially rectangular. In one embodiment the panel may be provided with an extension piece at one or each of the two opposite side edges. Preferably the extension pieces are provided with securing means to allow them to be wrapped around the corner of a vehicle and secured to the vehicle. Preferably an extension piece is provided on the leading edge of the sheet, the leading edge being the edge nearest the front of the vehicle when the panel is mounted on a vehicle. Alternatively the leading edge of the sheet may be provided with a continuous fastener which extends substantially over the entire length of the leading edge. In another embodiment the panel may be provided with an elongate fastener as described above on each of the two opposite side edges, the fastener being adapted to engage with a track member on the structure.

According to a second aspect of the present invention there is provided a vehicle, the vehicle having a wall provided with a slot or slots on the exterior surface thereof, the vehicle having an advertising panel mounted on said exterior surface, the panel comprising a sheet of plastic mesh material having an image applied to a first side of the sheet, wherein the panel has an elongate fastener provided on at least one longitudinal edge, the elongate fastener having a thickness greater than the sheet and engaged with said slot or slots on said vehicle.

Preferably the advertising panel is a panel according to the first aspect of the present invention. Preferably the exterior surface is on a side wall of the vehicle.

Preferably the slot or slots are provided in one or more track members bonded to the side wall by adhesive. Alternatively the track members may be secured to the side wall by fixing means such as bolts, screw, rivets or similar. Preferably the track members are extruded members. Preferably the slot or slots are shaped to allow keying of the elongate fastener with the slot or slots. In one preferred embodiment track members shaped to allow keying of the elongate fastener are provided on the upper and lower edges of the exterior surface, while lateral fastening members for securing the vertical side edges of the advertising panel are provided at the vertical side edges of the exterior surface. The lateral fastening members may be push-fit track members shaped to allow reversible snap engagement of the elongate fastener. Alternatively the lateral fastening members may be releasable clamping members which permit the clamping of the elongate fastener in a plurality of positions. Alternatively the lateral fastening members may be mutually engageable fastening means provided on the side wall and the advertising panel, such as hook and loop fasteners or 3M™ Dual Lock™.

The track members may extend continuously over the length of the elongate fastener. Alternatively, the track members are provided as discrete track members spaced at regular intervals on the vehicle.

According to a third aspect of the present invention there is provided a vehicle, the vehicle having a load bearing volume at least partially enclosed by a curtain, said curtain being provided with a slot or slots on the exterior surface thereof, the vehicle having an advertising panel on said exterior surface, the panel comprising a sheet of plastic mesh material having an image applied to a first side of the sheet, wherein the panel has an elongate fastener provided on at least one longitudinal edge, the elongate fastener having a thickness greater than the sheet and engaged with said slot or slots on said vehicle.

Preferably the advertising panel is a panel according to the first aspect of the present invention.

Preferably the slot or slots are provided in one or more track members bonded to the curtain by adhesive. Alternatively they may be secured to the curtain by thermal bonding, ultrasonic bonding, stitching, moulding or similar. Alternatively the track members may be secured to the curtain by fixing means such as bolts, screw, rivets or similar, preferably in conjunction with a washer plate on the opposite surface of the curtain. Preferably the track members are extruded members. Preferably the slot or slots are shaped to allow keying of the elongate fastener with the slot or slots. In one preferred embodiment track members shaped to allow keying of the elongate fastener are provided on the upper and lower edges of the exterior surface, while lateral fastening members for securing the vertical side edges of the advertising panel are provided at the vertical side edges of the exterior surface. Backing plates may be provided on the interior surface of the curtain with the lateral fastening members. The lateral fastening members may be push-fit track members shaped to allow reversible snap engagement of the elongate fastener. Alternatively the lateral fastening members may be releasable clamping members which permit the clamping of the elongate fastener in a plurality of positions. Alternatively the lateral fastening members may be mutually engageable fastening means provided on the curtain and the advertising panel, such as hook and loop fasteners or 3M™ Dual Lock™.

Preferably the track members are provided as discrete track members spaced at regular intervals on the vehicle.

According to a fourth aspect of the present invention there is provided a method of modifying a vehicle to display at least one advertising panel on at least one surface of the vehicle, the panel comprising a sheet of plastic mesh material having an image applied to a first side of the sheet, wherein the panel has an elongate fastener provided on at least one longitudinal edge, the elongate fastener having a thickness greater than the sheet said method comprising the steps of:

securing one or more slotted track members in a predetermined pattern on the surface of the vehicle or on a curtain adapted to be mounted on the surface of the vehicle, and

releasably attaching the advertising panel to the one or more slotted track members by engaging the elongate fastener in the slots provided on the one or more slotted track members.

Preferably the advertising panel is a panel according to the first aspect of the present invention.

Preferably the advertising panel is substantially rectangular having upper and lower longitudinal edges and two side edges, and elongate fasteners at the upper and lower longitudinal edges are engaged in the slots provided on the one or more slotted track members. The method may include the further step of:

releasably attaching the side edges of the advertising panel to one or more releasable clamping members.

Preferably at least one side edge is provided with an elongate fastener, and the side edge is attached to the one or more releasable clamping members by clamping the elongate fastener in a selected one of a plurality of positions, to adjust the lateral tension in the advertising panel. Push-fit track members may be used instead.

According to a fifth aspect of the present invention there is provided an advertising panel for mounting to a structure, the panel comprising a sheet of plastic material having an image applied to a first side of the sheet, wherein the panel has a plurality of resilient attachment means provided along at least one edge of the panel. Preferably the panel is of mesh material.

According to a sixth aspect of the present invention there is provided a vehicle having a rear door, the rear door having mounted thereon an advertising panel according to the fifth aspect of the present invention. Preferably the rear door is a roller shutter door. Preferably the rear door has attachment fixings secured thereto, each attachment means being attached to an attachment fixing. Preferably the resilient attachment means are adapted to allow elastic extension of the attachment means when the roller shutter door is in its rolled state with the advertising panel mounted thereon.

Preferably the resilient attachment means comprises elastic tension members of natural or synthetic rubber. These may be in the form of bands, loops, rods or any suitable form. They may pass through an eyelet in the panel, or they may be attached to the panel by any suitable securing means, including fasteners, rivets, adhesive and stitching.

Preferably the sheet is flexible. Preferably the sheet is of PVC, polyester or a combination thereof.

Preferably the mesh is provided with apertures allowing air passage therethrough. Preferably the sheet has an air permeability of at least 1000 litres per second at 100 pascal.

Preferably the sheet of the advertising panel is a woven material. Preferably the warp and weft fibres are bonded to each other at their intersections.

Embodiments of the invention will now be described by way of example only, with reference to the drawings in which:

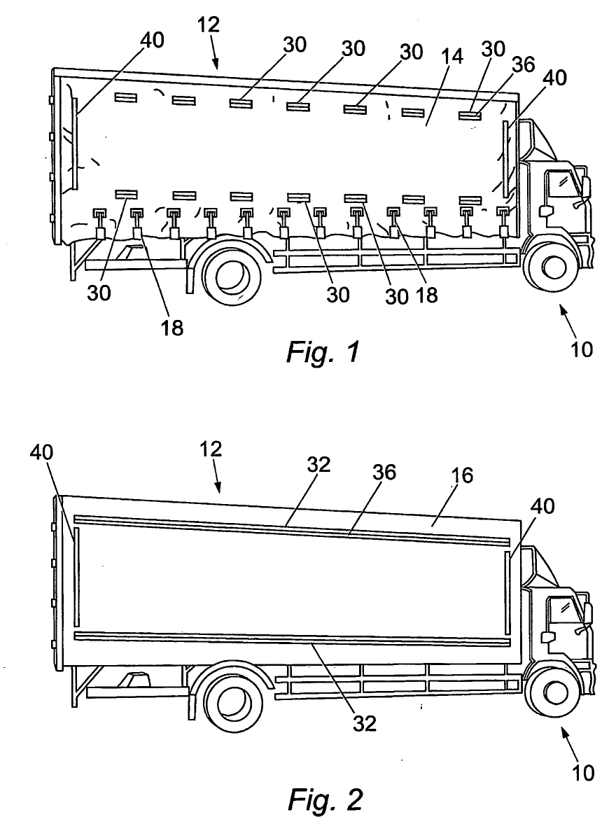

FIG. 1 shows a curtain-sided lorry provided with slotted track members to allow attachment of an advertising panel according to the invention;

FIG. 2 shows a rigid-sided lorry provided with slotted track members to allow attachment of an advertising panel according to the invention;

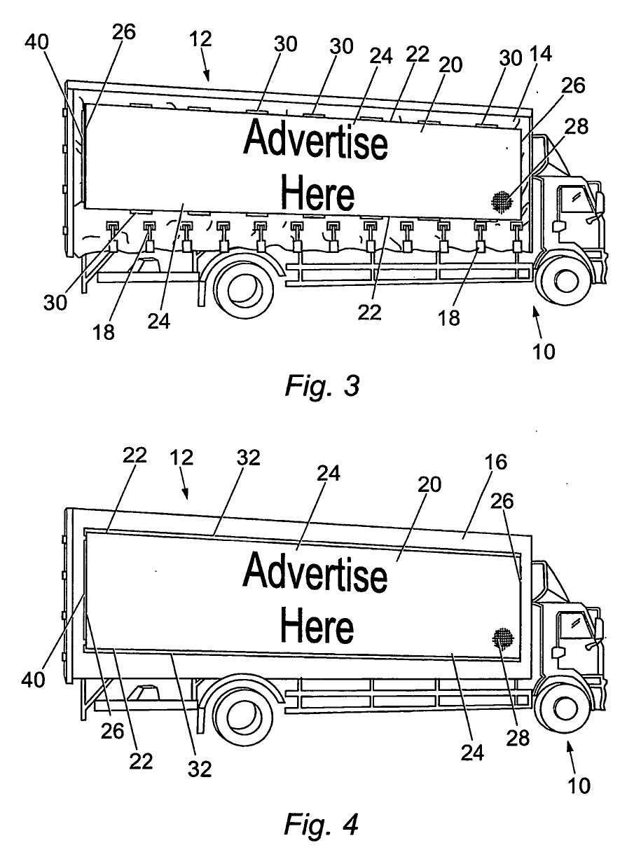

FIG. 3 shows the lorry of FIG. 1 with an advertising panel attached;

FIG. 4 shows the lorry of FIG. 2 with an advertising panel attached;

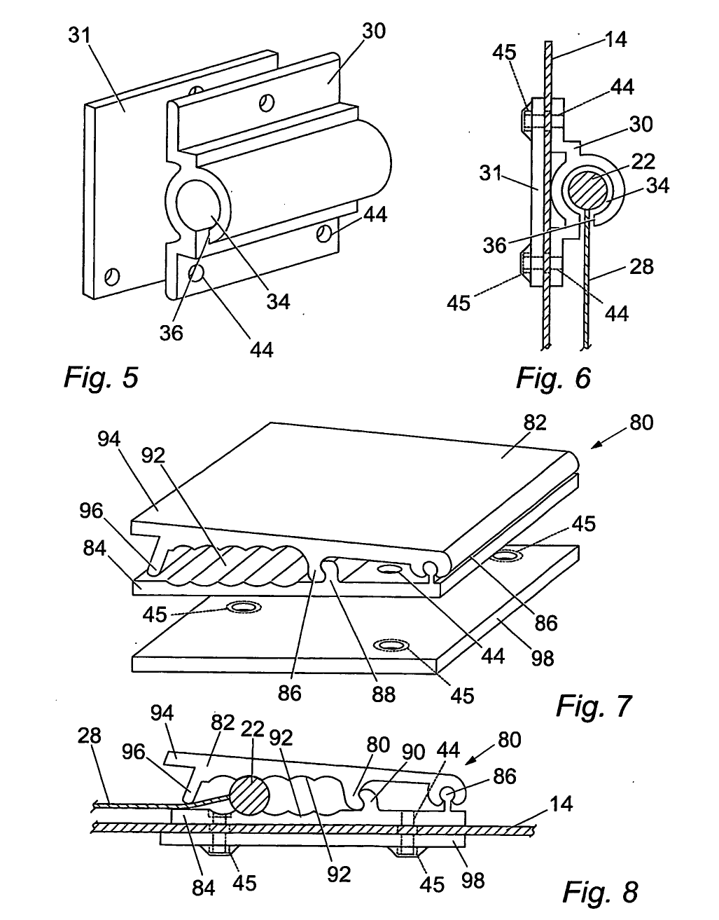

FIG. 5 shows a slotted track member and backing plate used to attach an advertising panel according to one embodiment of the invention;

FIG. 6 shows a sectional view of the slotted track member and backing plate of FIG. 5 attached to a curtain;

FIG. 7 shows a releasable clamping member and backing plate used to attach an advertising panel according to another embodiment of the invention;

FIG. 8 shows a sectional view of the releasable clamping member and backing plate of FIG. 7 attached to a curtain;

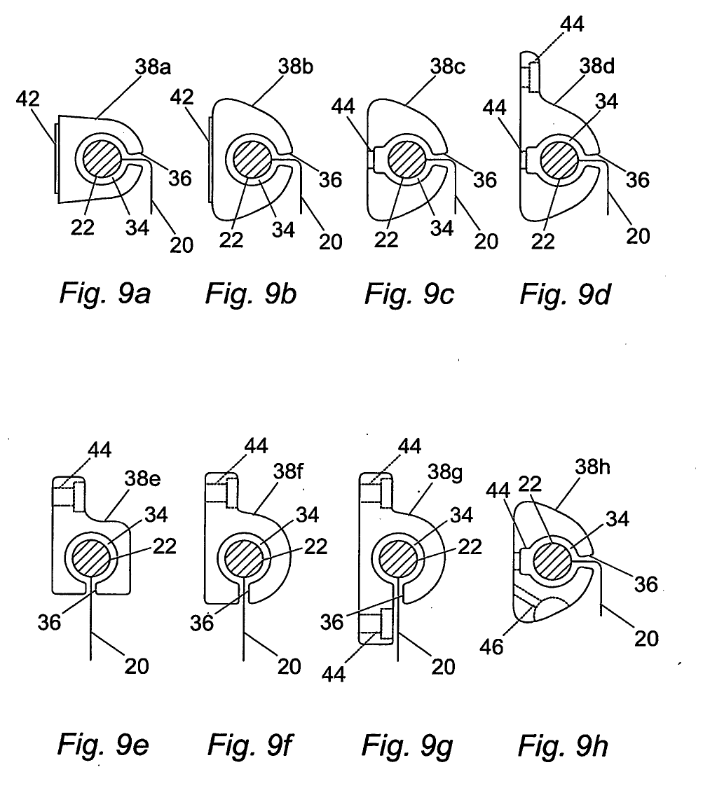

FIGS. 9a to 9h show sectional views of slotted track members and the attachment of the edge of the advertising panel according to various further embodiments of the invention;

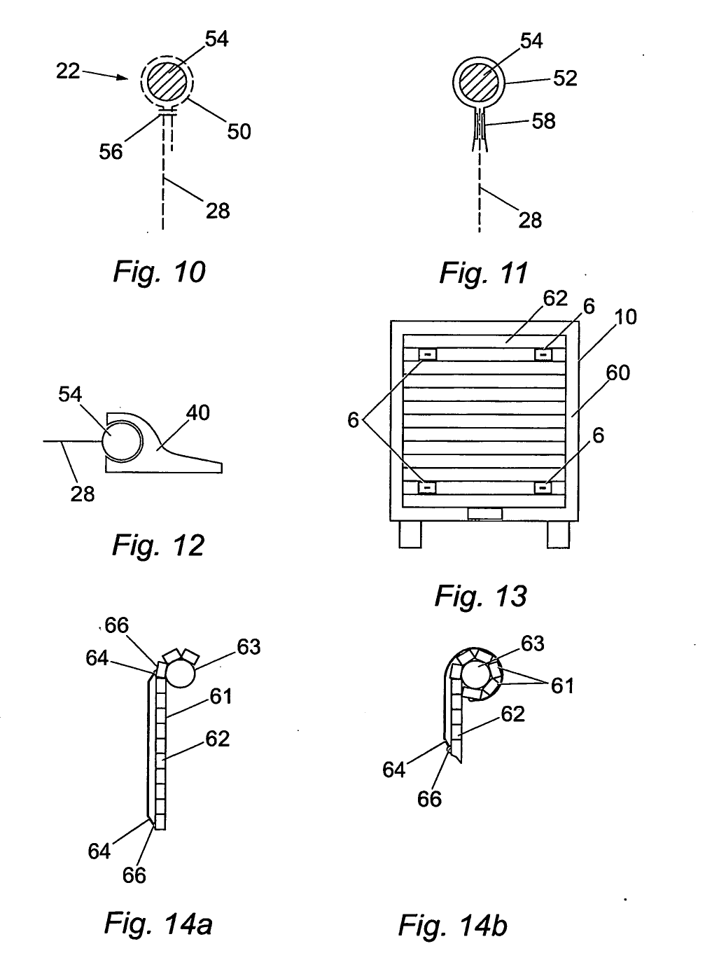

FIGS. 10 and 11 show alternative edge arrangements for the panels of FIGS. 1 to 9;

FIG. 12 shows a cross-sectional view of a push-fit track member which can be used to secure the side edges of the panels of FIGS. 1 to 9;

FIG. 13 shows a vehicle having a roller shutter door equipped to carry an advertising panel according to the invention;

FIGS. 14a and 14b are partial sectional views of the roller shutter door of FIG. 13 with an advertising panel attached in the unrolled and rolled positions;

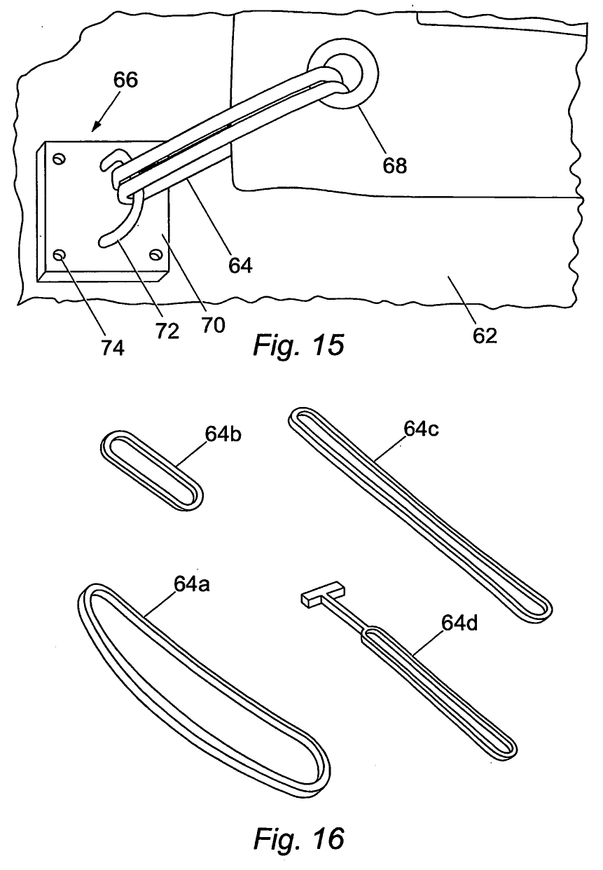

FIG. 15 shows an attachment means for the advertising panel of FIG. 14a; and

FIG. 16 shows various alternative attachment means for the advertising panel of FIG. 14a.

FIG. 1 shows a vehicle in the form of a lorry 10 having a load area 12 which is covered on each longitudinal side by a curtain 14. The curtain 14 is secured to the vehicle 10 at its upper edge and is tensioned in a conventional manner by means of tensioning straps 18 which connect the lower edge of the curtain to the vehicle. The curtain 14 and straps 18 are well known in the art and may be of any suitable flexible material. Typically the curtain 14 is of reinforced PVC while the straps 18 are of nylon webbing.

The surface of the curtain 18 has a number of slotted track members 30 fixed to it, seen more clearly in FIGS. 5 and 6, arranged in an upper row and a lower row. Typically these coincide with alternate vertical strengthening straps 18 of the curtain 14. They may be fixed by adhesive 42 or other suitable means of securing the members to the curtain, including fixing means such as bolts, screw, rivets, staples or similar. In practice the combination of stainless steel machine screws which pass through apertures 44 in the track member 30 and engage with integral nuts 45 in a backing plate 31 has been found to be an effective fastening means. Alternatively the slotted track members may be secured to the curtain by thermal bonding, ultrasonic bonding, stitching, moulding or similar. The slotted track members 30 are of moulded or extruded plastic and various other non-limiting shapes are shown in FIGS. 9a to 9f. The members have a cylindrical passage 34 extending therethrough and a slot 36 in one side, allowing access to the passage 34.

The slotted track members 30 are selected and positioned to engage with elongate fasteners 22 provided on the longitudinal edges 24 of an advertising panel 20, as shown in FIGS. 5, 12 and 13.

Two vertical push-fit track members 40, shown in FIG. 12, are also secured to the curtain, one at each side. These are secured to the curtain in the same way as the slotted track members 30, with backing plates (not shown) if appropriate.

FIG. 2 shows a lorry 10 having a load area 12 which is covered on each longitudinal side by a rigid wall 16. The arrangement of slotted track members 30 on the rigid wall 16 can be the same as that described above with respect to the curtain 14 of FIG. 1, although in FIG. 2 two continuous slotted track members 32 are shown, one upper member and one lower member, having the same cross-section as the shorter track member illustrated in FIGS. 5 and 6. Continuous track members 32 typically comprise a number of 3 metre long track members 32 fixed in abutting relationship. The members 32 are bonded to the wall by means of high bond double sided adhesive tape 42 or other adhesive, although it is to be understood that other suitable means of securing the members to the wall may be used, including fixing means such as bolts, screw, rivets, staples or similar. As in FIG. 1, two vertical push-fit track members 40 are also secured to the wall, one at each side. These are secured to the wall in the same way as the slotted track members 32.

FIG. 3 shows the curtain sided lorry 10 of FIG. 1 with an advertising panel 20 fixed to the curtain 14 using fasteners 22 which engage with the slotted track members 30 and the push-fit track members 40. The panel 20 is described in more detail below. The edges 24 of the panel 20 are threaded through the slots 36 starting at one end of the lorry 10. While FIG. 3 shows the panel 20 on a side wall of the vehicle 10, it is to be understood that the panel may be fitted to any surface of the vehicle 10, including the rear surface or the roof. The panel 20 is typically one metre shorter than the curtain 14 in length, and 2 metres in height.

FIG. 4 shows the rigid sided lorry 10 of FIG. 2 with an advertising panel 20 fixed to the wall 16 in the manner described above with reference to FIG. 3. The panel 20 is typically dimensioned to cover most of the surface area of the wall 16.

In both cases the vertical edges 26 of the panel 20 are engaged with the resilient extruded PVC push-fit track members 40 as shown in FIG. 14. However the vertical edges 26 may alternatively be attached by any other suitable means. For example, a strip of hook and loop fastener may be provided at each vertical edge of the advertising panel 20 to engage with a corresponding strip of hook and loop fastener provided on the wall 16 or curtain 14. Instead of hook and loop fastener other releasable fasteners may be used, such as 3M™ Dual Lock™ or releasable clamping members 80, described below. Alternatively the plastic mesh material of the panel 20 may be extended around the corner of the vehicle 10 and securing it to the structure of the vehicle in any suitable way.

The construction of the advertising panel 20 will now be described with reference to FIGS. 5, 6, 10 and 11. The panel comprises a sheet 28 of plastic mesh material. Typically the mesh material comprises a polyester or polypropylene base fabric coated with PVC. The base fabric may have between 3 and 10 (preferably 5) threads per cm in both warp and weft directions. Flexible plasticised PVC is applied to both sides to produce a material having a weight of between 100 and 800 g/m², preferably between about 200 and 550 g/m², such that the warp and weft fibres are bonded to each other at their intersections.

The apertures in the mesh allow an air permeability of between 1000 and 6000 litres/second at 100 pascal, preferably about 2800 litres/second. A suitable mesh is that sold by VUFLEX Digital under the name VUFLEX Digital 550, although it is to be understood that any suitable plastic mesh may be used. The air permeability ensures that the panel remains flat against the supporting surface, whether it be a solid wall of a vehicle or a curtain. Air pressure either side of the panel is equalised, thereby preventing flapping of the panel against the supporting surface.

The mesh must be capable of being printed on, to provide an advertising image on one side. Any suitable printing process may be used, such as laser printing or screen printing. The apertures must be small enough such that the effect of the advertising panel when mounted on a solid surface and viewed from a distance is of an opaque panel. In a particular embodiment the plasticised warp and weft fibres have a width of about 1 mm, while the apertures are about 1 mm square. An opaque effect is produced if the apertures make up about 25% or less of the area of the panel. If the apertures make up more than about 35% of the area of the panel the opacity effect is diminished.

Reinforcing strips (not shown) of reinforced PVC or similar material may be bonded to any or all of the edges of the mesh sheet 28 to prevent the advertising panel 20 from tearing or stretching in use. The reinforcing strips may be bonded by adhesive or by ultrasonic welding. The strips may be of polypropylene or polyester scrim coated with PVC for easy joining to the mesh sheet 28. The thickness of the strips is chosen so that the sheet 28 can be subject to the chosen printing process even with the strips attached. Typically the reinforcing strips are between 5 and 15 cm wide, and extend to the perimeter of the sheet 28.

Elongate fasteners 22 are bonded to the longitudinal edges 24 of the mesh sheet 28, with or without reinforcing strips, by wrapping the edge of the sheet around the fastener 22 and stitching with thread 56 or bonding to form a hem 50, as in FIG. 12, or by attaching and bonding an edge strip 52, as in FIG. 13, of any suitable plastic material. Thermal or adhesive 58 bonding may be used. The elongate fastener 22 comprises a cord or rope 54, or extruded flexible plastic or rubber, held in the hem 50 or edge strip 52. The cord or rope 54 may be free to slide in the hem 50 or edge strip 54, or may be restrained or bonded to the hem 50 or edge strip 52. Similar elongate fasteners 22 are provided on the vertical edges 26 of the panel if push-fit track members 40 or releasable clamping members 80 are used to secure the vertical edges. The edge strip 52 may be of the same material as the reinforcing strips described above.

The panel is installed on a vehicle 10 by threading the elongate fasteners 22 at the top and bottom edges of the panel 22 into the slotted track members 30,32 simultaneously and pulling the panel horizontally until it extends from one vertical side to the other of the supporting surface. The vertical edges of the panel are then secured using any suitable securing means.

It has been found that it is advantageous to provide a continuous fastener, preferably a fastener 22 which can engage with the push-fit track member 40 or a fastener such as a hook and loop fastener (not shown), extending all the way along the leading edge of the advertising panel 20. The leading edge is that edge which is nearer the front of the vehicle in use. The use of a continuous fastener engaging with a corresponding continuous fastener on the vehicle 10 prevents the leading edge of the panel 20 lifting away from the vehicle at any point, and helps to hold the panel 20 to the wall 16 or curtain 14 without flapping. The same effect can be achieved by continuing the panel around the corner of the vehicle and securing it in place by any suitable means to the end wall of the vehicle.

Particular arrangements of fasteners are provided for particular models of vehicles 10 and their corresponding advertising panels 20. For example a Transit® van might carry a particular size of advertising panel 20; panels for these vans would carry a particular pattern of fasteners. Corresponding fasteners on Transit® vans would be fixed to the side wall 16 of the van in a corresponding pattern using a particular Transit® stencil. Similarly, a particular make of trailer might carry a particular larger size of advertising panel 20; panels for these trailers would carry a different particular pattern of fasteners. Corresponding fasteners on the trailers would be fixed to the curtain 14 or side wall 16 of the trailer in a corresponding pattern using a particular trailer stencil.

Referring to FIGS. 5 and 6, there is shown a discrete slotted track member 30. It is to be understood that the continuous track member 32 has the same cross-section. The backing plate 31 used to connect the track member 30 to a curtain 14 by sandwiching the curtain 14 between the track member 30 and backing plate 31 has threaded sockets 45 which correspond in position to the apertures 44 in the track member 30. Screws or bolts (not shown) are used to secure the track member 30 and backing plate 31 together. Conventional bolts and nuts may be used instead of threaded sockets. Corresponding holes in the curtain 14 can be pre-formed or can be formed by insertion of the screws into the apertures 44.

Referring to FIGS. 9a to 9h, there are shown alternative cross-sectional profiles 38a-h of the discrete or continuous slotted track members 30, 32. Profiles 38a-d and 38h have the slot 36 in a side face, while profiles 38e-g have the slot 36 in a lower face so that the advertising panel 20 hangs straight, eliminating wear. Profiles 38a and 38b are attached by bonding using adhesive 42 or similar, while profiles 38c-h are attached using fasteners (not shown) which pass through apertures 44. A washer plate (not shown) may be used with nuts and threaded fasteners to secure the profiles 38c-h to a curtain 14, or conventional fasteners may be passed through the apertures 44 to secure the profiles 38c-h to a rigid wall 16.

In the embodiment of FIG. 9h screw holes 44 for securing profile 38h are provided in the passage 34, so that they remain hidden in use. Light fittings 46 are provided at spaced intervals along the track member for illumination of the advertising panel 20.

Referring to FIGS. 7 and 8, there is shown a releasable clamping member 80 which can be used instead of the push fit track member 40 to secure the lateral edges of the advertising panel 20, which are provided with an elongate fastener 22 as described above with reference to FIGS. 3, 4, 10 and 11. The clamping member 80 comprises an upper plate 82 and a lower plate 84 joined by a hinge 86. The upper and lower plates 82, 84 have corresponding detent portions 88, 90 which engage with each other in a snap fit to close the clamping member.

The upper and lower plates 82, 84 each have a ribbed surface 92 which can accommodate the elongate fastener 22 in a plurality of positions, such that the advertising panel 20 can be tensioned laterally and held in the position required to maintain tension. In this way the system can accommodate tolerances in the overall width of the advertising panel 20 or in the position of the clamping members 80 while still ensuring that the advertising panel 20 remains flat against the surface to which on it is mounted. The upper plate 82 has a handle portion 94 and a closure flange 96 which holds the mesh 28 of the panel 20 against the curtain 14 or wall 16. The clamping member can be secured to a curtain 14 using a backing plate 98 in the same way as described above with reference to the track member 30 and backing plate 31. The upper and lower plates 82, 84, like the track members 30, are of plastic such as polypropylene, and can be formed by extrusion.

In the embodiments described above, the advertising panel 20 of the invention has been described with reference to its mounting on a vehicle. However, it is to be understood that the advertising panel can be mounted on a fixed structure, such as a building or an advertising hoarding. In such cases slotted track members of the type herein described may be used to secure the advertising panel to the fixed structure. However, it is to be understood that suitable slots may be provided in other elements attached to the structure, and the invention is not to be limited to advertising panels mounted using slotted track members or releasable clamping members as described herein. In fixed or static structures or where the effects of air movement relative to the advertising panel are not significant, the plastic mesh may be replaced by a solid plastic sheet.

A method of attaching an advertising panel 20 to the rear of a vehicle which may be provided with a roller shutter door is now described with reference to FIGS. 13 to 16. A vehicle 10 has a rear wall 60 having a roller shutter door 62. Attached to the shutters of the door 62 at four corners are attachment fixings 66, comprising a plate 70, a loop 72 and apertures 74 for fasteners (not shown) such as screws, bolts, rivets or the like. An advertising panel 20 of the type described above with reference to FIGS. 1 to 9 is attached to the attachment fixings 66 by means of four resilient attachment means 64, of natural or synthetic rubber. FIG. 16 shows four possible shapes for the attachment means 64a-d, but is not to be construed as limiting on the shape. Moreover it is to be understood that more than four attachment means 64 may be used, or alternatively more or fewer resilient attachment means 64 may be used in conjunction with some other means of fastening, such as hook and loop fasteners (not shown) or the slot-engaging elongate fasteners 22 described above.

In the embodiment of FIGS. 13 to 16 the advertising panel can be used with resilient attachment means 64 only, so that the elongate fasteners 22 can be omitted. The resilient attachment means 64 allow stretching, so that when the roller shutter door 62 is opened by rolling the shutters 61 around a spool 63, as shown in FIG. 14b, the attachment means 64 become elongated to allow for the increased effective length between the top and bottom attachment fixings 66 resulting from the separation of adjacent shutters 61.

Modifications and variations of the above-described embodiments can be adopted without departing from the scope of the invention.

1. An advertising panel for mounting to a structure, the panel comprising a sheet of plastic material having an image applied to a first side of the sheet, wherein the panel has an elongate fastener provided on at least one longitudinal edge, the elongate fastener having a thickness greater than the sheet and being adapted to engage with a corresponding slot provided on the structure.

2. An advertising panel according to claim 1, wherein the advertising panel is mounted to the structure of a vehicle.

3. An advertising panel according to claim 1, wherein the advertising panel is mounted to a static structure.

4. An advertising panel according to claim 1, wherein the sheet has a hem and the elongate fastener comprises a longitudinal member held within the hem of the sheet.

5. An advertising panel according to claim 4, wherein the hem is formed by folding an edge of the sheet around the elongate fastener and back against the sheet, then securing the edge to the sheet.

6. An advertising panel according to any of claim 1, wherein the elongate fastener comprises a longitudinal member secured to the sheet by an edging strip.

7. An advertising panel according to claim 6, wherein the edging strip passes around the elongate fastener and is secured to each side of the edge of the sheet.

8. An advertising panel according to claim 1, wherein the longitudinal member is flexible.

9. An advertising panel according to claim 1, wherein the panel has an elongate fastener provided on two opposite longitudinal edges.

10. An advertising panel according to claim 1, wherein the sheet is flexible.

11. An advertising panel according to claim 1, wherein the sheet is a mesh of PVC, polyester, polypropylene or a combination thereof.

12. An advertising panel according to claim 1, wherein the mesh is provided with apertures allowing air passage therethrough, such that the sheet has an air permeability of at least 1000 litres per second at 100 pascal.

13. An advertising panel according to claim 1, wherein the sheet of the advertising panel is a woven material.

14. An advertising panel according to claim 13, wherein the woven material has warp and weft fibres bonded to each other at their intersections.

15. An advertising panel according to claim 1, wherein the panel is substantially rectangular.

16. An advertising panel according to claim 1, wherein the panel is provided with an extension piece at one or both of the two opposite side edges, said one or both extension pieces being provided with securing means to allow them to be wrapped around the corner of a vehicle and secured to the vehicle.

17. An advertising panel according to claim 1, wherein one or both of the two opposite side edges are provided with reclosable interlocking, fasteners adapted to engage with corresponding interlocking fasteners on the structure.

18. (canceled)

19. An advertising panel according to claim 1, wherein one or both of the two opposite side edges are provided with an elongate fastener having a thickness greater than the sheet on each of the two opposite side edges, the fastener being adapted to engage with one or more lateral fastening members on the structure.

20. An advertising panel according to claim 19, wherein the one or more lateral fastening members are releasable clamping members adapted to clamp the elongate fastener in a selected one of a plurality of positions.

21. A vehicle having a wall provided with a slot or slots on the exterior surface thereof, the vehicle having an advertising panel mounted on said exterior surface, the panel comprising a sheet of plastic mesh material having an image applied to a first side of the sheet, wherein the panel has an elongate fastener provided on at least one longitudinal edge, the elongate fastener having a thickness greater than the sheet and engaged with said slot or slots on said vehicle.

22. A vehicle according to claim 21, wherein the advertising panel is an advertising panel according to claim 1.

23. A vehicle according to claim 21, wherein the exterior surface is on a side wall of the vehicle.

24. A vehicle according to claim 21, wherein the slot or slots are provided in one or more track members bonded to the exterior surface by adhesive.

25. A vehicle according to claim 21, wherein the slot or slots are provided in one or more track members secured to the side wall by fixing means.

26. A vehicle according to claim 24, wherein the track members are extruded members, and the slot or slots are shaped to allow keying of the elongate fastener with the slot or slots.

27. A vehicle according to claim 26, wherein one or more of said track members are provided on each of the upper and lower edges of the exterior surface.

28. A vehicle having a load bearing volume at least partially enclosed by a curtain, said curtain being provided with a slot or slots on the exterior surface thereof, the vehicle having an advertising panel on said exterior surface, the panel comprising a sheet of plastic mesh material having an image applied to a first side of the sheet, wherein the panel has an elongate fastener provided on at least one longitudinal edge, the elongate fastener having a thickness greater than the sheet and engaged with said slot or slots on said vehicle.

29. A vehicle according to claim 28, wherein the advertising panel is an advertising panel according to claim 1.

30. A vehicle according to claim 28, wherein the slot or slots are provided in one or more track members bonded to the exterior surface by adhesive.

31. A vehicle according to claim 28, wherein the slot or slots are provided in one or more track members secured to the side wall by fixing means.

32. A vehicle according to claim 31, wherein each of said track members has a corresponding backing plate on the opposite side of the curtain, the fixing means passing through the curtain and joining the corresponding track member and backing plate.

33. A vehicle according to claim 28, wherein the track members are extruded members, and the slot or slots are shaped to allow keying of the elongate fastener with the slot or slots.

34. A vehicle according to claim 33, wherein one or more of said track members are provided on each of the upper and lower edges of the exterior surface.

35. A vehicle according to claim 28, wherein the track members are provided as discrete lengths of track spaced at regular intervals on the vehicle.

36. A method of modifying a vehicle to display at least one advertising panel on at least one surface of the vehicle, the panel comprising a sheet of plastic mesh material having an image applied to a first side of the sheet, wherein the panel has an elongate fastener provided on at least one longitudinal edge, the elongate fastener having a thickness greater than the sheet said method comprising the steps of: securing one or more slotted track members in a predetermined pattern on the surface of the vehicle or on a curtain adapted to be mounted on the surface of the vehicle, and releasably attaching the advertising panel to the one or more slotted track members by engaging the elongate fastener in the slots provided on the one or more slotted track members.

37. A method according to claim 36, wherein the advertising panel is an advertising panel according to claim 1.

38. A method according to claim 36, wherein the advertising panel is substantially rectangular having upper and lower longitudinal edges and two side edges, and wherein elongate fasteners at the upper and lower longitudinal edges are engaged in the slots provided on the one or more slotted track members, including the further step of: releasably attaching the side edges of the advertising panel to one or more releasable clamping members.

39. A method according to claim 38, wherein: at least one side edge is provided with an elongate fastener, the side edge is attached to the one or more releasable clamping members by clamping the elongate fastener in a selected one of a plurality of positions, to adjust the lateral tension in the advertising panel.

40. An advertising panel for mounting to a structure, the panel comprising a sheet of plastic mesh material having an image applied to a first side of the sheet, wherein the panel has a plurality of resilient attachment means provided along at least one edge of the panel.

41. A vehicle having a rear door, the rear door having mounted thereon an advertising panel according to claim 40.

42. A vehicle according to claim 41, wherein the rear door is a roller shutter door.

43. A vehicle according to claim 42, wherein the rear door has attachment fixings secured thereto, each attachment means being attached to an attachment fixing and being adapted to allow elastic extension of the attachment means when the roller shutter door is in its rolled state with the advertising panel mounted thereon.

44. A vehicle according to claim 41, wherein the resilient attachment means comprises elastic tension members of natural or synthetic rubber.
